(19) United States
(12) Patent Application Publication
(10) Pub. No.: US 2010/0158612 A1
(43) Pub. Date: Jun. 24, 2010

(54) METHOD FOR REMEDIATING NITRO AND/OR HALOGENATED COMPOUND-CONTAMINATED SOIL, SEDIMENT OR WATER USING GRAPHITIC CARBON AS A CATALYTIC SORBENT

(75) Inventor: Pei C. Chiu, Hockessin, DE (US)

Correspondence Address: RATNERPRESTIA, P.O. BOX 1596, WILMINGTON, DE, 19899, US

(73) Assignee: University of Delaware, Newark, DE (US)

(21) Appl. No.: 12/644,806

(22) Filed: Dec. 22, 2009

Related U.S. Application Data
(60) Provisional application No. 61/140,329, filed on Dec. 23, 2008.

(51) Int. Cl. B09C 1/08; C02F 1/28; C02F 1/70

(52) U.S. Cl. 405/128.5; 210/757; 210/668; 977/903

(57) ABSTRACT

Methods of remediating soil, sediment or water contaminated with organic compounds such as polychlorinated biphenyls or nitro-aromatic compounds are provided which involve combining the soil, sediment or water with a graphitic carbon and a reducing agent. The contaminants are converted to substances having an increased propensity to enter into an aqueous phase and/or undergo further degradation via biological oxidation.

### CROSS-REFERENCE TO RELATED APPLICATIONS

This application claims priority from U.S. Provisional Application No. 61/140,329, filed Dec. 23, 2008, and incorporated herein by reference in its entirety for all purposes.

### STATEMENT REGARDING FEDERALLY SPONSORED RESEARCH

This invention was made with U.S. Government support. The Government may have certain rights in the invention through the National Science Foundation (NSF) under federal grant number EPS-0447610.

### FIELD OF THE INVENTION

The invention pertains to methods useful for treating soil, sediment or water to reduce the amount of organic contaminants contained therein.

### BACKGROUND OF THE INVENTION

Many aromatic compounds, including polychlorinated biphenyls (PCBs), nitro-aromatic compounds (NACs), substituted benzenes and polycyclic aromatic hydrocarbons (PAHs), are widespread environmental contaminants. The prevalent contamination of freshwater and marine sediments with PCBs (a group of legacy chemicals that have been banned since the 1970s) remains one of the most challenging environmental problems to date. Excavation and capping of sediments are exorbitantly expensive and have many serious drawbacks. In-situ remediation is a preferred approach, but few viable technologies are currently available. Microbial degradation of PCBs is known to occur, but the process is very slow and often involves very long lag times.

NACs and other nitrogenous compounds, such as nitramines and azo aromatic compounds, are ubiquitous contaminants in soils and sediments due to their uses as explosives, agrochemicals, personal care products, dyes and pigments, and intermediates in the chemical industry. Through commercial and consumer use, military training, weapons manufacture and testing, waste disposal and other activities, these compounds have become common contaminants in sediment and soil environments.

The sorption of organic contaminants to carbonaceous sorbents is an important process that controls the fate and transport of these contaminants in aquatic environments and in remediation systems. It is generally assumed that when an organic molecule is physically sorbed (e.g., via van der Waals interactions) to sorbents like natural organic matter and activated carbon, it becomes sequestered, immobilized and inaccessible. Unlike its counterparts in a mobile (aqueous) phase, a sorbed molecule is believed to be incapable of undergoing chemical transformations such as hydrolysis and oxidation-reduction (redox) reactions. A sorbed molecule is also often assumed to be not bioavailable and hence not able to biodegrade, bioaccumulate or exert toxic effects.

Risk assessments for contaminated soils and sediments are usually performed based on these assumptions. One proposed remediation approach involves the addition of carbonaceous sorbents, such as activated carbon, to contaminated sediments and soils to decrease the equilibrium bioavailable (i.e., aqueous) concentrations of PCBs and PAHs. While potentially effective in minimizing the adverse ecological impacts of these organic contaminants, physical sorption to activated carbon is not a destructive process and thus does not reduce total contaminant mass. In fact, by storing a portion of the contaminant mass and releasing it only slowly over time, PCB- and PAH-laden activated carbon may in effect serve as a long term source of contamination in soil and sediments.

### SUMMARY OF THE INVENTION

It has now been unexpectedly discovered that graphitic carbon can serve not only as an adsorbent for organic contaminants but also as a catalyst for the reduction of the adsorbed organic contaminants. This finding was surprising in view of the widespread assumption in the field that when an organic compound is sorbed to a geosorbent such as a graphitic carbon, it becomes sequestered and inaccessible. Unlike its counterparts in aqueous solution, a graphitic carbon-sorbed molecule had been thought to be biologically and chemically inert.

However, the inventors have found that soil, sediment or water (e.g., groundwater) contaminated with one or more organic compounds such as polychlorinated biphenyls (PCBs) or nitroaromatic compounds may be remediated by admixing the contaminated soil, sediment or water with a graphitic carbon. A reducing agent such as reduced iron (e.g., elemental iron) or a sulfur-containing compound capable of being oxidized (e.g., thiols, H₂S, sodium sulfide) is also present in the admixture (as a result of being part of the contaminated soil, sediment or water and/or as a result of being introduced to the admixture or contaminated soil, sediment or water). Other suitable reducing agents such as manganese (or other metal capable of being oxidized) or hydroquinones (or other organic compounds capable of being oxidized) may also be used. Without wishing to be bound by theory, it is believed that the organic compounds are adsorbed onto the graphite and undergo reductive degradation catalyzed by the graphitic carbon, thereby forming more water soluble, more readily biodegradable or potentially less toxic compounds.

The present invention also provides a method for reducing the concentration of an organic compound in soil, sediment or water. This method comprises contacting the soil, sediment or water with a graphitic carbon in the presence of a reducing agent under conditions effective to sorb the organic compound onto or into the graphitic carbon and to cause the graphitic carbon to catalyze the reduction of the organic compound.

### BRIEF DESCRIPTION OF THE DRAWINGS

FIG. 1 illustrates in schematic form a possible mechanism by which the present invention may function.

FIG. 2 is a graph showing the results of the first experiment described in the Examples section.

### DETAILED DESCRIPTION OF CERTAIN EMBODIMENTS OF THE INVENTION

The present invention is especially suitable for treating soil, sediment or water contaminated with one or more organic compounds that are susceptible to reductive degradation. The organic compound contaminant may be a nitro-substituted organic compound, a halogen-substituted organic compound, or an aromatic organic compound or a mixture of such compounds. For example, the invention is particularly useful for remediating soil, sediment and water containing PCBs and NACs and other halogen- and/or nitro-substituted aromatics. Other types of contaminants which can be effectively treated using the present invention include, but are not limited to, nitrate esters, heterocyclic nitramines, nonaromatic nitro compounds and azo dyes.

The present invention utilizes one or more types of graphitic carbon, which may be described as any carbon substance containing graphitic domains. Graphite (also known as black lead or plumbago) is a mineral which is a crystalline allotropic form of carbon. The graphitic carbon may additionally contain forms of carbon other than graphite (i.e., non-graphitic domains) as well as non-carbon substances. Thus, the term “graphitic carbon” is intended to include all varieties of substances containing the element carbon in the allotropic form of graphite, irrespective of the presence of structural defects. Suitable types of graphitic carbon include, but are not limited to, graphite, carbon nanotubes, fullerenes, soot, char, charcoal, carbon fiber, and graphene. Activated carbon containing graphitic domains in its structure may also be suitable. The use of an electrically conductive graphitic carbon such as graphite is preferred, since such substances are capable of transferring electrons or hydrogen atoms from an external reducing agent to a contaminant molecule sorbed on its surface, thereby facilitating its transformation. The contaminant molecule thus can be reduced even if not in physical contact with the reducing agent. In the present invention, the graphitic carbon may be utilized in any suitable finely divided and/or high surface area form, such as particles, powder, flakes, porous pellets or crystals. Natural as well as synthetic graphitic carbons can be used. The graphitic carbon may be supported on or combined with other substances and materials. The amount of graphitic carbon employed relative to the amount of soil, sediment or water to be remediated can be varied as desired, which will depend upon (among other factors) the concentration of organic compound contaminants in the soil, sediment or water, the surface area and activity of the graphitic carbon, and the like. Since the graphite acts as a catalyst, it may be possible to use relatively low concentrations of graphite. As the organic compound molecules initially adsorbed onto the graphitic carbon are reductively degraded, they are converted to less hydrophobic substances which may then desorb from the graphitic carbon, making it possible for the graphitic carbon to adsorb and degrade additional organic compound contaminant molecules still present in the contaminated soil, sediment or water.

The amount of graphitic carbon utilized in the process of the present invention may be varied as desired depending upon the activity of the graphitic carbon selected for use, the concentration(s) and type(s) of contaminants in the sample of soil, sediment or water to be remediated, among other parameters.

Reducing agents suitable for use in the present invention include any substance or material capable of being oxidized, thereby reducing the organic compound which is a contaminant in the soil, sediment or water and which is targeted for removal or reaction. Particularly suitable reducing agents include, but are not limited to, elemental iron, manganese, hydroquinones and sulfur-containing compounds capable of being oxidized such as thiols and sulfides (which may be organic or inorganic). In one embodiment of the invention, the reducing agent(s) and graphitic carbon(s) are physically mixed or combined. In another embodiment, the reducing agent may be coated onto or absorbed into particles of the graphitic carbon. Alternatively, the graphitic carbon may be coated onto or otherwise combined with particles of the reducing agent. In one embodiment of the invention, the reducing agent is soluble in water. However, in another embodiment, the reducing agent is water-insoluble.

The amount of reducing agent used should be sufficient to effect reduction of the contaminants present in the soil, sediment or water to the desired extent. In one embodiment, an amount of reducing agent is employed that is effective to convert essentially all of the targeted contaminant(s) to other compounds.

The reductive reaction of the organic compound contaminant generally converts such compounds into less strongly sorbed, more water-soluble (less hydrophobic), and more aerobically degradable substances. Hence, in one aspect of the invention, the graphitic carbon will tend to accumulate the most hydrophobic and reduction-prone contaminants on its surface. Following reduction of such compounds facilitated by the reducing agent and the graphitic carbon, the more water-soluble (less hydrophobic) degradation products thereby generated will exhibit a greater tendency to desorb and pass into an aqueous phase in contact with the graphitic carbon, where they will become available for subsequent biological oxidation and further breakdown.

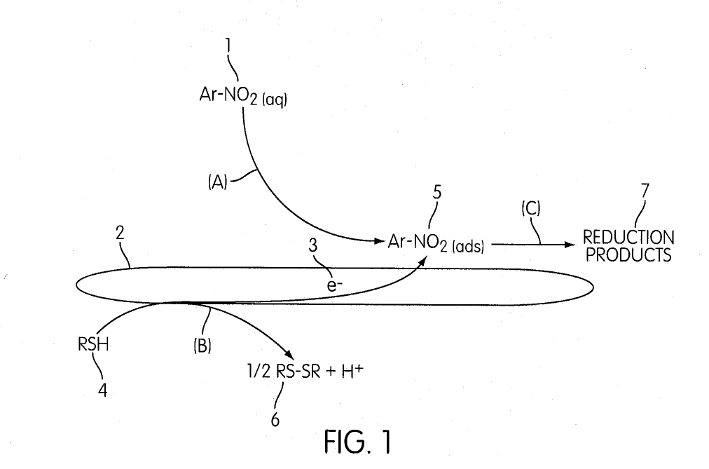

Without wishing to be bound by any particular theory, FIG. 1 illustrates in schematic form a possible mechanism by which the present invention may function. As shown in FIG. 1, step (A) involves sorption of a nitro-substituted aromatic compound 1 from an aqueous phase onto a graphitic carbon particle 2. In step (B), an electron 3 transfers from thiol 4 through the graphitic carbon particle 2 to sorbed nitro-substituted aromatic compound 5, with thiol 4 being oxidized to disulfide compound 6. The sorbed nitro-substituted aromatic compound 5 is reduced in step (C) to reduction product(s) 7, which may then desorb from graphitic carbon particle 2.

The soil, sediment or water is contacted with the graphitic carbon in the presence of the reducing agent under conditions effective to sorb the organic compound onto or into the graphitic carbon and to cause the graphitic carbon to catalyze the reduction of the organic compound. Such conditions may vary depending upon the type, concentration and reactivity of organic compound(s) in the material to be subjected to remediation as well as the type, concentration and reactivity of the graphitic carbon(s) and reducing agent(s) selected for use, but may be readily ascertained by standard procedures without undue experimentation. Typically, such contacting may be conveniently carried at ambient temperatures and pressures (e.g., about 10 to about 40° C. and about atmospheric pressure). However, if so desired, the admixture of soil, sediment and/or water; graphitic carbon; and reducing agent may be heated above ambient temperature, which generally will tend to increase the rate at which the organic compound contaminants are converted. The contacting may be carried out for a period of time sufficient to accomplish the desired extent of extent of the contaminants, e.g., at least about 1 hour to about 4 weeks or even longer.

The graphitic carbon and/or reducing agent may be mixed into the contaminated soil, sediment or water in any suitable way. In the case of a sediment, the mixing may be accomplished during the normal operations of hydraulic dredging, in which sediment (which may contain water) is pumped through a well, pipeline or hose into a holding container. The graphitic carbon and/or reducing agent may be injected (as a slurry or suspension in water, for example) into the well, pipeline or hose at a predetermined rate, thus achieving adequate mixing. Alternatively or additionally, graphitic carbon and/or reducing agent could be added to the sediment at the point of discharge into a barge or holding vessel or disposal location. If a clam shell or bucket is used for dredging sediment or removing contaminated soil, graphitic carbon and/or reducing agent may be mechanically mixed into the sediment or soil when it is dumped into the barge, holding vessel, truck, or disposal location. The mixing may occur during dumping or subsequent to dumping. Any type of mechanical mixing could be employed, including but not limited to bulk stirring. Alternatively or additionally, mixing may be accomplished by layering the soil or sediment and the graphite. The graphitic carbon and/or reducing agent could be injected into the soil or sediment (using an aqueous suspension or slurry of graphitic carbon particles, for example) or spread on the surface of the contaminated soil or sediment and plowed or otherwise mixed into the soil or sediment using a tractor, bulldozer, clamshell crane or other such equipment. Another approach is to form a slurry of the contaminated soil, sediment or water with the graphitic carbon and/or reducing agent, providing agitation of the slurry to ensure thorough and intimate mixing.

The present invention may be used to remediate contaminated groundwater, by either in situ or above ground methods. For example, one suitable technique involves pumping groundwater contaminated with one or more organic compounds from underground into a vessel or other holding container (e.g., a catch basin) wherein the groundwater is admixed or contacted with the graphitic carbon and reducing agent. Once the desired reduction of the organic compound contaminant(s) has been achieved, the water may be separated from the graphitic carbon and/or unreacted reducing agent and/or oxidized product(s) obtained by reaction of the reducing agent (by filtration, for example) and returned underground, optionally being first subjected to one or more further purification steps (e.g., biological oxidation). Another possible approach is to pass contaminated water through or over a bed of graphitic carbon, with the reducing agent either being admixed with the graphitic carbon or added to the stream of contaminated water before being introduced into the graphitic carbon bed. If the reducing agent is admixed (as a solid material, for example) with the graphitic carbon in such a bed, once the reducing agent has been depleted (through oxidation, for example) the bed may be replaced or periodically regenerated (e.g., by subjecting the bed to reducing conditions effective to regenerate the reducing agent). Another method for cleaning contaminated groundwater in accordance with the present invention is to provide a permeable in-ground barrier or curtain comprising graphitic carbon and, optionally, reducing agent. The barrier or curtain is positioned such that the contaminated groundwater tends to flow through the barrier or curtain (injection techniques and the like may be used to induce the desired direction of groundwater flow). The organic chemical contaminants are at least partially reacted when the contaminated water passes through the barrier or curtain. The barriers may be semi-permanent or replaceable units that are installed across the flow path of groundwater. For example, the barrier or curtain may be placed where a contaminant plume moves through it as it flows, with treated water exiting on the other side of the barrier or curtain.

### EXAMPLES

To demonstrate the efficacy of the invention, an experiment was conducted using 2,4-dinitrotoluene (DNT) as a test contaminant compound and graphite particles (99.9%, 20-84 mesh, Alfa Aesar) as the graphitic carbon component. The specific surface area of the graphite was determined by the BET adsorption method with nitrogen to be 1.5 m²/g. Dithiothreitol (DTT, 98%, Sigma-Aldrich) was used as a model reducing agent.

Duplicate 250 mL amber glass bottles were set up in an anaerobic glove box (N₂/H₂, 95/5), each containing 200 mL of DNT solution at pH 7.4 and 10 g of graphite particles. One bottle contained reducing agent, while the other did not. Aqueous samples were collected at different elapsed times and filtered immediately for liquid chromatographic (LC) analysis. The concentrations of DNT and its reduction product, 2,4-diamino-toluene (DAT), and two intermediates, 2-amino-4-nitro-toluene (2A4NT) and 4-amino-2-nitro-toluene (4A2NT), were determined using the analytical methods described in Oh et al., “Graphite-mediated reduction of 2,4-dinitro-toluene with elemental iron,” Environ. Sci. Technol. 36:2178-2184, 2002.

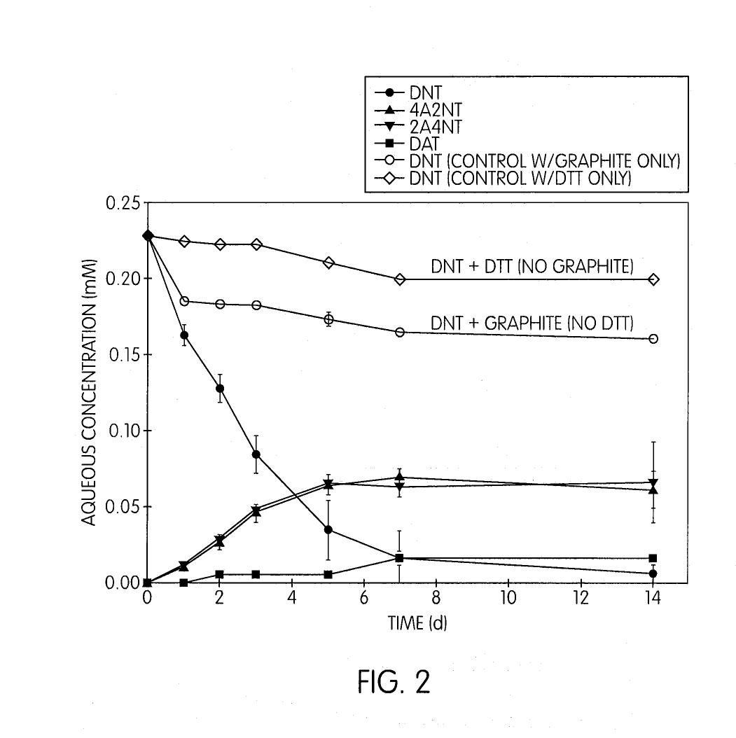

The results of this experiment are shown in FIG. 2. The open symbols are data from the controls (lacking either graphite or the reducing agent DTT) and the solid symbols are data from the bottles containing both DTT and graphite. DNT was not significantly reduced by DTT in homogeneous solution (no graphite present) over two weeks. At the end of the testing period, only traces of 4A2NT (close to the detection limit of the method) were observed, but no 2A4NT or DAT was found. This clearly indicates that in the absence of a graphitic carbon such as graphite, the reduction of DNT by a thiol is relatively slow. In the DTT-free control containing graphite, a fraction of the DNT was quickly removed from the aqueous phase, presumably due to sorption of the DNT onto the graphite particles. However, subsequent removal was limited and no reduction products of DNT were detected over 14 days. Apparently, DNT was adsorbed, but not reduced, by the graphite.

In contrast, when both DTT and graphite were present in accordance with the invention, DNT was almost completely removed from the water in two weeks. This result was unexpected in light of the prevailing assumption that molecules sorbed onto graphitic carbon become essentially unavailable or inaccessible for further reaction. Concomitantly, the two intermediates 2A4NT and 4A2NT and the final product DAT were produced, with their concentrations in the aqueous phase increasing with time. The aqueous concentrations of 2A4NT and 4A2NT were approximately the same.

What is claimed is:

1. A method for remediating soil, sediment or water contaminated with one or more organic compounds, said method comprising mixing a graphitic carbon with said soil, sediment or water to form a mixture that additionally contains at least one reducing agent.

2. The method of claim 1, wherein the at least one reducing agent is initially present in the soil, sediment or water.

3. The method of claim 1, wherein the at least one reducing agent is added to the soil, sediment or water or to a mixture of the graphitic carbon and soil, sediment or water.

4. The method of claim 1, wherein the mixture contains at least one reducing agent selected from the group consisting of reduced iron, manganese, hydroquinones and oxidizable sulfur-containing compounds.

5. The method of claim 1, wherein the one or more organic compounds include at least one aromatic compound.

6. The method of claim 1, wherein the one or more organic compounds include at least one nitro-substituted compound.

7. The method of claim 1, wherein the one or more organic compounds include at least one halogen-substituted compound.

8. The method of claim 1, wherein the graphitic carbon is selected from the group consisting of graphite, carbon nanotubes, fullerenes, soot, char, charcoal, carbon fiber, activated carbon and graphene.

9. The method of claim 1, wherein the mixing is carried out in-situ.

10. The method of claim 1, wherein the graphitic carbon is electrically conductive.

11. The method of claim 1, wherein the graphitic carbon comprises graphite particles.

12. The method of claim 1, wherein the graphitic carbon is in contact with an aqueous phase.

13. A method for reducing the concentration of an organic compound in a soil, sediment or water, said method comprising contacting said soil, sediment or water with a graphitic carbon in the presence of a reducing agent under conditions effective to sorb the organic compound onto or into said graphitic carbon and to cause the graphitic carbon to catalyze the reduction of the organic compound.

14. An admixture comprising a soil, sediment or water contaminated with one or more organic compounds, at least one graphitic carbon, and at least one reducing agent.

15. The admixture of claim 14, wherein the admixture contains at least one reducing agent selected from the group consisting of reduced iron, manganese, hydroquinones and oxidizable sulfur-containing compounds.

16. The admixture of claim 14, wherein the one or more organic compounds include at least one compound selected from the group consisting of aromatic compounds, nitro-substituted compounds and halogen-substituted compounds.

17. The admixture of claim 14, wherein the graphitic carbon is selected from the group consisting of graphite, carbon nanotubes, fullerenes, soot, char, charcoal, carbon fiber, activated carbon and graphene.

18. The admixture of claim 14, wherein the graphitic carbon is electrically conductive.

19. The admixture of claim 14, wherein the graphitic carbon comprises graphite particles.

20. The admixture of claim 14, wherein the graphitic carbon is in contact with an aqueous phase.
